(19) United States
(12) Patent Application Publication
(10) Pub. No.: US 2011/0189555 A1
(43) Pub. Date: Aug. 4, 2011

(54) Apparatus for Supplying a Fuel Cell in a Fuel Cell System with Fuel Gas

(75) Inventors: Thomas Baur, Weilheim (DE); Stefan Gerhardt, Westerstetten (DE); Oliver Harr, Reichenbach (DE); Matthias Jesse, Dettingen (DE); Andreas Maier, Uhingen (DE); Cosimo Mazzotta, Ulm (DE); Patrick A. Padgett, Wilmington, NC (US); Hans-Joerg Schabel, Reutlingen (DE); Klaus Scherrbacher, Deggingen (DE); Thomas Winkeler, Seizisau (DE)

(73) Assignees: Daimler AG, Stuttgart (DE); Ford Global Technologies, LLC, Dearborn, MI (US)

(21) Appl. No.: 13/060,916

(22) PCT Filed: Aug. 27, 2009
(86) PCT No.: PCT/EP2009/006223

§ 371 Date: Apr. 6, 2011

(30) Foreign Application Priority Data
Aug. 30, 2008 (DE) 102008045170.3
Nov. 25, 2008 (DE) 102008058960.8

(51) Int. Cl. H01M 8/06

(52) U.S. Cl. 429/414; 429/415

(57) ABSTRACT

An apparatus for supplying a fuel cell in a fuel cell system with fuel gas is provided. The fuel cell system includes a mixing region, where unused fuel gas mixes with fresh fuel gas, a water precipitator, a device for the at least indirect heating of the supplied fresh fuel gas and at least one receptor for a sensor for sensing state variables and/or chemical magnitudes of the fuel gas flowing to the anode. The mixing region, water precipitator, device for the at least indirect heating and at least one sensor are combined in an integrated component part.

### CROSS REFERENCE TO RELATED APPLICATIONS

This application is a national stage of PCT International Application No. PCT/EP2009/006223, filed Aug. 27, 2009, which claims priority under 35 U.S.C. § 119 to German Patent Application No. 10200804517.3, filed Aug. 30, 2008 and German Patent Application No. 102008058960.8, filed Nov. 25, 2008, the entire disclosures of which are herein expressly incorporated by reference.

### BACKGROUND AND SUMMARY OF THE INVENTION

The invention relates to an apparatus for supplying a fuel cell in a fuel cell system with fuel gas, especially hydrogen.

Fuel cell systems that are typically operated with hydrogen of a hydrogen-containing gas as fuel gas are basically known in the state of the art. These fuel cell systems essentially consist of a fuel cell, for example a fuel cell with a polymer membrane as electrolyte, a so-called PEM fuel cell. The fuel cell will generally consist of a stack of single cells, and thus is also referred to as a fuel cell stack. With systems of this type, an anode side of the fuel cell is supplied with the fuel gas and typically a part of unused fuel gas, which is returned from a region behind an anode side of the fuel cell to the region in front of the anode side of the fuel cell. The cathode side of the corresponding fuel cell is supplied with an oxygen-containing gas, typically air. These fuel cells then generate electrical energy from just this fuel gas and the oxygen in the air. A typical purpose of use is, for example, within the scope of electrical drive trains of vehicles.

The installation space and weight of these fuel cell systems play an important role, particularly during the construction of such a vehicle drive train in the fuel cell system. DE 10 2004 049 623 A1 discloses an end plate for a fuel cell stack, which integrates a conveyor device for a reactant, a reaction product and/or a coolant into an end plate of such a fuel cell stack.

One disadvantage with this construction is that corresponding vibrations enter into the fuel cell stack by the pump, which can affect its leak tightness. Furthermore, dismantling of the fuel cell stack is always required for maintenance of the pump, which is also a disadvantage because the stack is already sensitive with regard to its seals. The exchange of, for example the fuel cell stack or the pump, also always requires the opening of the fuel cell stack, with a subsequent resealing thereof, which is comparatively elaborate particularly with hydrogen as conveyed fuel gas.

DE 102 48 611 A1 discloses a fuel cell system and a method for preheating the fuel cell or the fuel cell stack. So as to design the preheating during a cold start or at a low temperature more efficiently and evenly, this document describes more evenly distributing the thermal energy content contained in the compacted air flowing to the cathode side of the fuel cell. For this, the hydrogen gas flowing to the fuel cell system, which serves as fuel here, is preheated via a heat exchanger via the air heated during compacting by means of a fuel air heat exchanger. Because the heat enters into the gas flow of the fuel originates from the compacted air, the available heat is only distributed differently via this construction, however, the entered heat amount is altogether not increased.

Exemplary embodiments of the present invention provide a fuel cell system with a practical construction that can be maintained easily with a minimal installation space, which is especially suitable for compact and highly loaded fuel cell systems.

The integration of most of the fuel gas relevant components, that is, especially the integration of the mixing region, a water precipitator, a device for heating the fuel gas and receptions for at least one sensor into the one integrated component part offers critical advantages during the use of the installation space available. The integrated component part enables a space-saving arrangement of the essential fuel gas conducting elements and short line lengths, and thus correspondingly low pressure losses in the fuel gas. Furthermore, the integrated component part, which can be designed independently of the fuel cell stack, can be mounted independently of the fuel cell stack, and which can be easily dismantled for maintenance. Possible vibrations or temperature fluctuations in the integrated component part are also not transferred to the fuel cell stack, and thus do not influence its tightness in a negative manner by different thermal expansions or vibrations.

Furthermore, all relevant elements are combined in the integrated component part, so that the fuel gas, especially the hydrogen, can be provided with predetermined pressure, volume flow, predetermined temperature and predetermined gas composition (for example hydrogen concentration and humidity). Water in liquid form is also discharged from the recirculated unused fuel gas. Special attention is directed to the device for heating the fuel gas. During the operation of the fuel cell system, the fuel, typically hydrogen, is supplied to the fuel cell system from a pressure storage device. This fuel is, however, often very cold because the pressure storage device is typically arranged in a region—for example of a vehicle—that is not or only minimally insulated. The fuel in the pressure storage device thus has an ambient temperature, which is rather cold compared to the typical operating temperature in the magnitude of about 70 to 100 ° C. in the fuel cell system. Furthermore, thermal energy is additionally lost from the pressure storage device during the relaxation of the fuel, so that a—at least compared to the system—very cold hydrogen—or fuel flow reaches the fuel cell system. The lower the outer temperature and the shorter time the fuel cell system is operated, the more critical is this cold fuel flow, as it shows heat sinks in the system, where water present in the gases of the system can condense out or possibly even freeze.

This effect is reduced considerably by the integrated device for heating the fuel, so that a better operation and particularly a safer and faster cold start of the fuel cell system of the device can be ensured for generating energy.

The device for heating the fuel has the further advantage, especially with a cold start of the fuel cell system, that the integrated component part itself and all components therein are also heated and can thereby possibly be defrosted, so that for example the one corresponding discharge line for water via which excess inert gases can also be blown off, is already defrosted during the start of the system and is fully functional.

The integrated component part can furthermore be designed in such a manner that it does not need an additional carrier frame, so that a corresponding installation space can be saved in addition to the reduction of the mass, construction volume and also costs, and the gas volume of the fuel gas-conducting elements is furthermore reduced considerably. The shortened line lengths enable, in addition to the compact construction, provide a reduction of the pressure losses also a reduction of the necessary sealing locations, which is an important advantage, especially with the use of hydrogen. The integrated component part can also be manufactured considerably more economical due to the integration and the omitted interface, as the requirement of manufacturing tolerances can be reduced correspondingly.

In a further very beneficial arrangement of the apparatus according to the invention, the cooling water of the fuel cell system passes through the integrated component part. This integration of the cooling water or of the cooling water supply to the fuel cell itself in the integrated component part constitutes a further advantage with regard to the line lengths and the interfaces between the lines. The cooling water is also heated via the at least one device for the at least indirect heating of the supplied fresh fuel gas, as all component parts are connected at least in an indirectly heat-conducting manner in the integrated component part. With this, not only the fresh fuel gas, but also the cooling water can be heated via the device for heating, so that the device for heating can also be used for heating the fuel cell itself, for example in a cold start situation. In reverse, heat from the cooling water can also be used for heating the supplied fresh fuel gas. With this, energy can be saved and waste heat which is present in any case can be used for heating the fresh fuel gas.

In a further very beneficial and advantageous arrangement of the apparatus according to the invention, the at least one device for the at least indirect heating of the supplied fresh fuel gas is formed as an electrical heater. Such an electrical heater can be received very simply and efficiently in the integrated component part, for example by an electrical resistor. By the very easy accessibility and thus the very simple and efficient generation of a desired heat amount in the electrical heater, the supplied fresh fuel gas can be heated very efficiently to a predetermined end temperature. Furthermore, a heating of the entire integrated component unit can take place by additional electrical heating performance, for example to preheat this during a cold start of the fuel cell system and to possibly defrost it.

In the aspect of the device according to the invention where the cooling water of the fuel cell system additionally flows through the integrated component part, the cooling water and thus the fuel cell can also be heated, so that the electrical heater can be used simultaneously as electrical starting heater, without such a heater having to be integrated additionally into the fuel cell system. Thus, with the apparatus according to the invention, the number of component parts can be reduced and the construction volume of the fuel cell system can be reduced.

In a supplemental or alternative arrangement aspect of the apparatus according to the invention, the at least one device for the at least indirect heating of the supplied fresh fuel is formed as a cooling heat exchanger for at least one heat-generating component, wherein the fresh fuel gas at least partially cools the heat-generating component. The heating of the fuel gas via a cooling heat exchanger to a heat-generating component of the fuel cell system enables it to use thermal energy already present in the fuel cell system. As a further positive side effect, the respective heat-supplying component is at least partially cooled by the fuel gas flow, so that its operation can proceed in a temperature region which is suitable for the optimum operation. The cooling heat exchanger and/or the heat-generating component can thereby also be integrated into the integrated component unit or be mounted to it.

The component can thereby be each component actively generating heat or waste heat in a fuel cell system, for example electronics or power electronics, whose waste heat has to be cooled, or also a unit with electromotive drive where the engine should to be cooled to ensure an ideal function. Such a device can, for example, be a fan or a compression unit, however, it can also be a drive motor with use in a transport means. It would be a further possibility that the fuel gas takes on the cooling of an electrochemical component, as for example of the fuel cell stack itself or a battery, which is possibly present in addition to the fuel cell stack, and heats up thereby. Here, a traction battery with a vehicle drive system can be especially considered, which can then be formed as a high performance battery, for example on the basis of the lithium ion technology. However, other components of the fuel cell system are also feasible, for example an electrically supported turbo charger for compacting the conveyed air for the cathode side or the like. Finally, other components are still also feasible, where the heat results through the processes proceeding therein, for example condensers or fluid precipitators, which generate heat through the corresponding condensation heat, which could then be transferred to the fuel. Furthermore, the heat-generating component in the context of the invention could also be a heat exchanger, which is supplied with heat from the outside in a second circuit via a medium.

This heat-generating component in the context of the invention is then cooled at least partially by the fuel flow. Depending on the respective component and the respectively demanded characteristic of the cooling, for example in the partial load operation, under full load, during idling or the like, it is possible that the respectively available fuel gas flow is not sufficient to ensure the cooling. If this is the case, the cooling via the fuel gas can also be set up as an additional cooling, so that the cooling heat exchanger is, for example, present in addition to a further cooling heat exchanger in or at the component. The cooling in situations and operating states where cooling via the volume flow of the inflowing fuel gas is not sufficient can then be ensured via this further heat exchanger for example via a conventional cooling circuit with a cooling fluid.

In a further very beneficial and advantageous arrangement of the apparatus according to the invention, the fuel cell system furthermore comprises a recirculation conveyor device, through which unused fuel gas is returned from one region behind an anode of the fuel cell to a region in front of the anode, wherein this recirculation conveyor device is mounted to the integrated component part. By the mounting of the recirculation conveyor device, for example a hydrogen recirculation fan, the line length between the integrated component unit and the recirculation conveyor device is reduced, and the recirculation conveyor device can be connected to the integrated component unit without further carrier frames or the like and be carried by it. As this typically still has its own cooling, this mounting can be a very advantageous alternative due to reasons of maintenance, so as to ensure accessibility and possibly exchangeability of the recirculation conveyor device. By the mounting of the recirculation conveyor device, an at least indirect heat conduction between the recirculation conveyor device and the integrated component part can furthermore be achieved. The device for the at least indirect heating of the supplied fresh fuel gas can then, especially when using a high heating performance, also heat the recirculation conveyor device in the case of a cold start up to a certain degree, and possibly defrost droplets frozen therein.

In an alternative arrangement of the apparatus according to the invention, it is provided that such a recirculation conveyor device is at least partially implemented in an integral manner in the integrated component part. With this, the recirculation conveyor device could completely be housed in the integrated component part, or only the hydrogen-conducting part can be integrated in the integrated component part. A possible drive motor, for example in a canned construction, could then be mounted from the outside. With this, it would be ensured that all hydrogen-conducting parts are integrated in the integrated component part, so that the problem regarding line lengths and sealing locations are improved still further. Furthermore, a very good heating of the recirculation conveyor device via the device for the at least indirect heating of the supplied fresh fuel gas would be possible by the integration. With this, the recirculation conveyor device could, for example, also be heated via the integrated component unit.

Exemplary uses of such an economic, small, compact and comparatively light component part with regard to its mass, include in a transport means on land, on water or in the air, and particularly in a farm vehicle without rails. The above-mentioned advantages can be used especially effectively here, it is thereby not important if the apparatus is used for additional energy generation or for the generation of energy for the drive train of such a transport means.

### BRIEF DESCRIPTION OF THE DRAWING FIGURES

Further advantageous arrangements of the invention result from the dependent claims and are explained in more detail in the following by means of an embodiment.

It shows thereby:

FIG. 1 is a schematic depiction of a section of a fuel cell system with the apparatus according to the invention,

FIG. 2 is a principal layout of the apparatus according to the invention in a first embodiment,

FIG. 3 is a principal layout of the apparatus according to the invention in a further embodiment,

FIG. 4 is an alternative possibility for realizing the device for heating the supplied fresh fuel gas flow; and

FIG. 5 is a further alternative possibility for realizing the device for heating the supplied fresh fuel gas flow.

### DETAILED DESCRIPTION

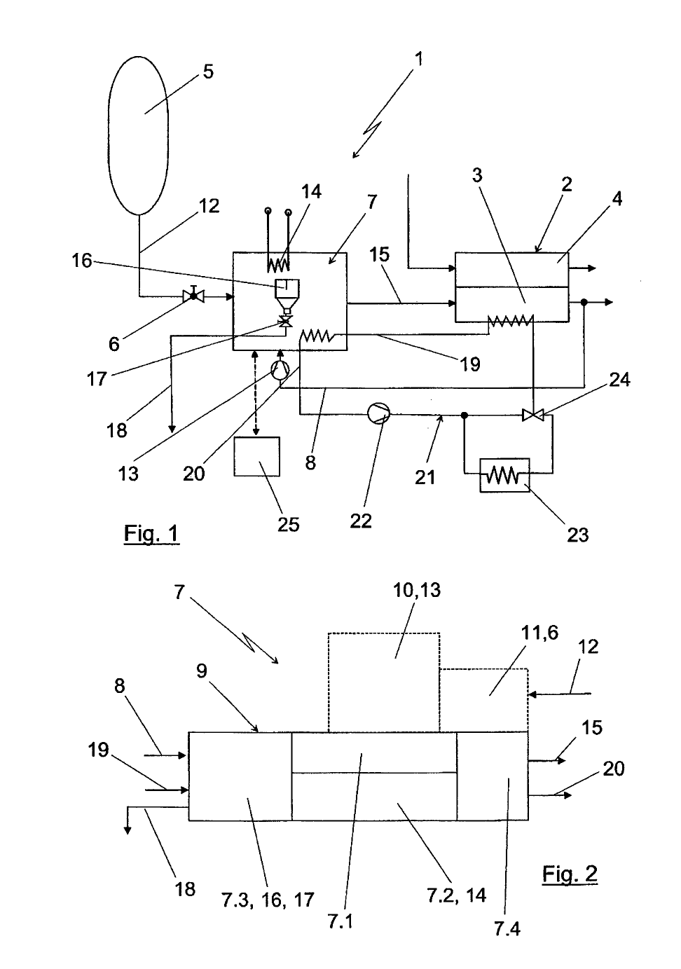

FIG. 1 illustrates a part of a fuel cell system 1 in principle. A fuel cell 2 can be seen as an essential component of the fuel cell system 1, which cell can typically be formed as a fuel cell stack, for example as a stack of PEM fuel cells. The fuel cell 2 comprises an anode region 3 and a cathode region 4. The cathode region 4 is supplied with an oxygen-containing oxidation means, for example air, by a conveyor, not shown in detail here. The supply of the anode region 3 with the fuel gas, especially hydrogen here, takes place from a hydrogen pressure tank 5, which is shown here in an exemplary manner with an associated valve device 6. The hydrogen now flows into an integrated component part 7 from the pressure tank 5 via the valve device 6, and from there further into the anode region 3 of the fuel cell 2. Hydrogen gas which has not been converted is also returned to the region of the integrated component part 7 via a recirculation line 8.

FIG. 2 illustrates the integrated component part 7 in an exemplary embodiment. The integrated component part 7 thereby comprises a housing 9, which combines all fuel gas-conducting elements therein, and two mounted component elements 10, 11, which form the integrated component part 7 together with the housing 9. The component elements 10, 11 are mounted directly to the housing 9, so that the integrated component part 7 itself forms a self-supporting unit which can forego external carrier elements such as frame structures or the like. The integrated component part 7 is formed with the housing 9 or part of the housing as a self-supporting unit in such a stable manner, that it not only can support itself, but can also support the fuel cell stack 2 connected thereto. Alternatively to this self-supporting arrangement of the integrated component part 7, which is connected to the fuel cell 2, it would also be feasible to form the integrated component part 7 directly as one of the end plates of the fuel cell stack 2.

With the exemplary highly schematic depiction of the integrated component part 7 in FIG. 2, the one mounted component element 11 comprises the pressure control valve, that is, the valve device 6, which is arranged between the high pressure tank 5, not shown here, and the integrated component part 7. The component element 11 accordingly contains the valve device 6 and a corresponding connector line 12, which originates from the pressure tank 5. The second mounted component element 10 comprises the motor and electronic components of a recirculation pump 13 as recirculation conveyor device for the unused anode gas. Depending on the layout of the recirculation pump 13, the mounted part will possibly also comprise the compactor wheel itself in addition to the electronic components and the motor, while the compressor wheel housing is arranged in the part of the housing 9 referenced as 7.1. Alternatively, another constructive type and manner of the integration can be chosen with the embodiment, for example as canned motor. Alternatively or additionally, a gas jet pump, not shown here, can be provided in the component part 7 for the recirculation of the anode waste gas. The recirculation conveyor device 13 could alternatively also be completely integrated in the integrated component part 7.

In addition to the region 7.1 already described, which can comprise the wheel housing for the compactor of the recirculation pump 13, the housing 9 comprises further integrated regions. The region referenced as 7.2 can thus, for example, comprise an electrical heater 14 as device for heating the fresh supplied fuel gas. Basically, a single central electrical heater 14 can be provided, which is connected to heat-conducting materials with all regions or media which are to be heated via corresponding regions. Alternatively, the electrical heater 14 can also be divided into individual elements, so that certain regions within the housing 9 can respectively be heated individually, for example corresponding valve devices, the wheel of the recirculation pump 13, corresponding sensor connectors or also partial regions of a water precipitator 16, which is to be arranged in the region 7.3.

In the region 7.4 of the housing 9, a mixing region is also arranged, in which the fresh hydrogen supplied from the pressure tank 5 via the line 12 mixes with the unused fuel gas recirculated via the recirculation pump 13, which reaches the integrated component part 7 via the recirculation line 8. The corresponding fuel gas then reaches the anode 3 of the fuel cell 2 via the conduction element 15. At least in this mixing region 7.4 in the housing 9 sensors or receptors for sensors are arranged, so that state variables and/or chemical magnitudes of the fuel gas conducted to the anode 3 of the fuel cell 2 can be sensed via the line 15. Typical magnitudes here would be pressure, temperature and volume flow, humidity and hydrogen concentration in the fuel gas.

In the region 7.3, which shall comprise the water precipitator 16, a discharge valve 17 can also be arranged, which is not shown explicitly. Accumulating water can be discharged via this discharge valve via the line element 18. Non-combustible gas accumulated over time in the system due to the recirculation can also be blown off together with the water via this line element 18. These elements are also integrated in the region 7.4 of the housing 9 by integration in such a manner that these are thermally bound to the housing 9 and can thereby also be heated in the region 7.2 via the electrical heater 14. Thus, the function of these component elements is always ensured. The water precipitator 16 can be principally constructed in an arbitrary manner in the region 7.4 of the housing 9. It is, however, also feasible to combine the water precipitator 16 with the recirculation pump 13 in such a manner that the rotary movement of the compactor wheel of the recirculation pump 13 transports possibly occurring droplets by the centrifugal force into the region of the compactor wheel housing, in which a discharge and precipitation of these liquid droplets can be realized via corresponding grooves or the like. The rotary energy of the compactor wheel of the recirculation pump 13 can thus also be used for improving the water precipitation.

It can also be provided in the housing 9 that all fluid-conducting parts, that is, especially the parts reached by water after the precipitation, are formed in such a manner that their walls continuously open in the cross section in the direction to a fuel gas or air cushion. By this opening in the direction of an air cushion, which in the general case of use will typically be in a direction against gravity, a construction is achieved, which will not be damaged during the freezing of the liquid water present therein. The arrangement in which ice forming is not blocked in its expansion, but can slide into the region of an air or fuel gas cushion, avoids the corresponding stresses exerted on the material of the housing 9 by the expansion of the ice, which can lead to material failure.

The housing 9 comprises two additional line elements 19, 20 in FIG. 2. The integrated component part 9 can optionally be connected to the cooling circuit 21 of the fuel cell system 1 via these line elements 19, 20, which is indicated schematically in FIG. 1. The cooling circuit 21 comprises a conveyor device 22 and a cooler 23, through which excess heat can be discharged to the environment. Furthermore, it proceeds through the fuel cell 2, and, as already indicated, optionally through the integrated component part 7. The cooling circuit 21 further comprises a valve device 24, which bypasses the cooler 23. During a cold start, the cooler 23 is switched out of the cooling circuit 21 via this valve device 24. As this is a fast heating of the fuel cell system 1, one is interested in the cooling water heating as quickly as possible in the cooling circuit 21. If the cooling circuit 21 is now conducted through the integrated component part 7, this can also be heated in the region 7.2 with the correspondingly dimensioned electrical heater 14. This has the advantage that thermal energy can be entered into the fuel cell system 1 with a single electrical heater 14, which is then also used as start-up heater, for the cold start case of the fuel cell system 1. In the integrated component part 7, all relevant fuel gas conducting regions arranged in the housing 9 or mounted thereto, and the fuel gas flowing to the anode region 3 are heated correspondingly by the electrical heater 14, in the region 7.2, which is again shown in an exemplary manner in FIG. 1. By the heating of the cooling water in the cooling circuit 21, a distribution of this heat in the entire fuel cell system 1 including the fuel cell 2 can also be achieved. A very fast heating of the fuel cell system 1 is thereby enabled, wherein only one single electrical heater 14 is needed in the region 7.2 of the integrated component part 7. This is advantageous with regard to the activation and the line conduction.

As has already been mentioned, the corresponding sensors are integrated in the region 7.4 of the housing 9 depicted in FIG. 2, the integrated component part 7 can also correspond to an electrical regulating device 25, as is indicated in an exemplary manner in FIG. 1. This electronic regulating unit can then be connected to the integrated component part 7 via corresponding line elements, but it is also feasible that this electronic control unit 25 is also mounted to the integrated component part 7 or the housing 8 thereof and is also part of the integrated component part 7.

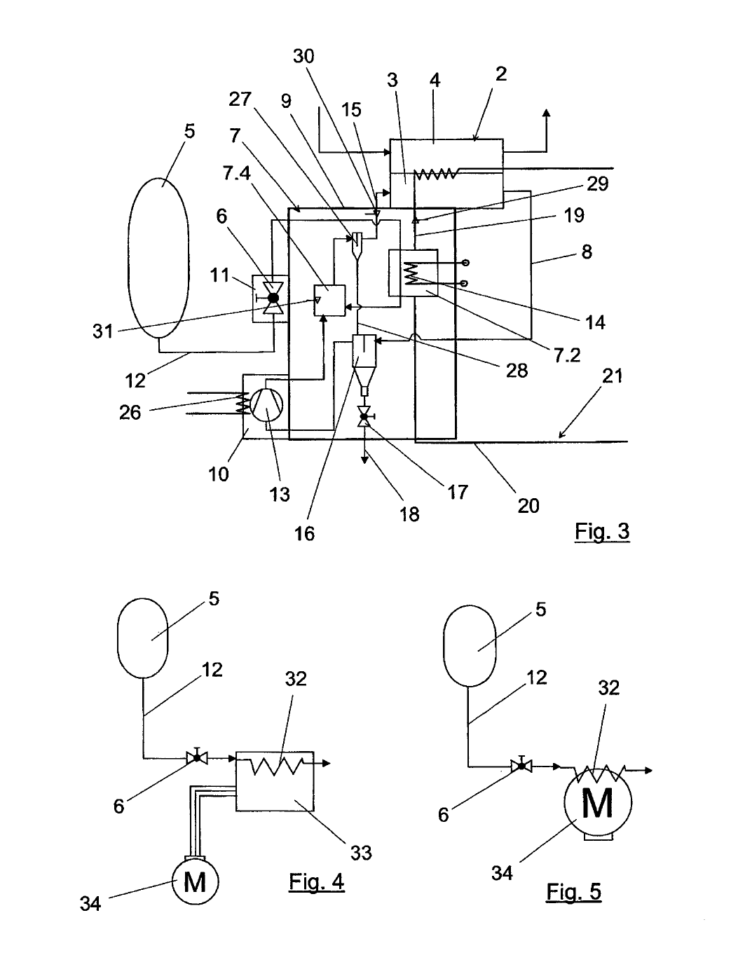

FIG. 3 illustrates a further exemplary embodiment of the integrated component part 7. This is also designed as a self-supporting component part 7 and can either be connected to an end plate of the fuel cell stack 2, or can directly form such an end plate of the fuel cell stack 2. The integrated component part 7 in the embodiment according to FIG. 3 is arranged in such a manner that it comprises the water precipitator 16 and the valve device 17. The waste gas from the region of the anode 3 of the fuel cell 2 is supplied to the water precipitator 16 via the recirculation line 8. Liquid water is precipitated in the water precipitator 16, and the anode waste gas then reaches the region of the recirculation conveyor device 13, which is designed in the embodiment of the integrated component part 7 shown here mounted thereto. In the depiction of FIG. 3 it can also be seen that the recirculation conveyor device 13 comprises a heat exchanger 26, via which an electromotive drive unit of the recirculation conveyor device 13 can be cooled. The heat exchanger 26 can for example be designed as integrated in the cooling circuit 21.

After the recirculation conveyor device 13, the anode waste gas flows into the mixing region 7.4, where it is mixed with fresh fuel gas from the pressure tank 5. The fresh fuel gas from the pressure tank 5 thereby flows to the mixing region 7.4 via the valve device 6, which is also formed as a valve device 6 mounted to the integrated component part 7. Before it reaches the mixing region 7.4, the fuel gas also flows through the region 7.2 of the integrated component part 7, in which the electrical heater 14 is arranged as the device for heating the fresh supplied fuel gas. The electrical heater 14 also serves for the conditioning or temperature control of the fresh supplied fuel gas. The gases mixed with one another then reach a water trap 27, in which droplets possibly present in the gas are precipitated, which were, for example, condensed out by the cooler fresh fuel gas in the comparatively warm anode waste gas. This is necessary to prevent liquid water from clogging the channels for distributing the fuel gas in the anode region 3 of the fuel cell 2. The integration of the water trap 27 into the integrated component part 7 thereby offers the advantage that these devices can be omitted in the interior of a fuel cell 2 or in a gas supply region within the fuel cell 2. All of the liquid water thus accumulates in the region of the integrated component part 7. This water can then flow from the water trap 27 via the line 28 shown dashed here into the region of the water precipitator 16, for example, through a suitable arrangement of the water trap 27 at a higher height than the water precipitator 16. The fuel gas free from drops then reaches the region of the anode chamber 3 of the fuel cell 2 and can be correspondingly converted there.

Furthermore, a part of the cooling circuit 21 passes through the integrated component unit 7 in the embodiment according to FIG. 3. The cooling water flowing in the cooling circuit 21, typically a mixture of water and an anti-freeze, reaches the region of the integrated component unit 7 via the line 20. There it flows through the region 7.2 and then reaches the heat exchanger integrated in the fuel cell 2 via the line 20 to discharge the heat resulting there. Although the remaining construction of the cooling circuit 21 is omitted in the depiction of FIG. 3, it is constructed analogously to the cooling circuit 21 shown in FIG. 1. In the region 7.2, there is now also the cooling water conducted through the integrated component unit 7 in addition to the electrical heater 14 and the fresh fuel gas, respectively in separate lines. This can also be heated very efficiently by the electrical heater 14, so that a very fast heating results during the cold start of the fuel cell. For this, only one electrical heater 14 is necessary, which has to be dimensioned in such a manner that it can make the corresponding power for heating the fuel cell 2 available, as the necessary electrical power in the regular operation for heating the fresh fuel gas.

In the embodiment shown here, all media supplies and discharges to the anode side 3 of the fuel cell 2 and the supply of the cooling water are integrated in the component part 7. This saves corresponding line elements and can be mounted very simply and efficiently via a suitable interface, for example, between the integrated component unit 7 and an end plate of the fuel cell stack 2. If the integrated component unit 7 is the end plate itself, even this part of the mounting can be omitted.

In the integrated component unit 7 in the depiction of FIG. 3, a few sensors or receptors for sensors are furthermore indicated in an exemplary manner. A first temperature sensor 29 is depicted, which measures the input temperature of the coolant in the fuel cell 2 or the exit temperature of the coolant from the integrated component unit 7, which is equivalent here. A further temperature sensor 30 is in the region in which fuel gas flows into the anode chamber 3 of the fuel cell 2 and senses the corresponding temperature there. Furthermore, a pressure sensor 31 can be seen in the depiction of FIG. 3, which is arranged in the mixing region 7.4 and serves for sensing the pressure, especially the pressure of the fresh supplied fuel gas. Further sensors can naturally be integrated in the component unit 7, or the component unit 7 can comprise corresponding connectors for such sensors. Further sensors could be sensors for sensing temperatures and pressures, or for example also a sensor for sensing the pressure difference between the anode chamber 3 and the cathode chamber 4.

Alternatives can now be seen in the depictions of FIGS. 4 and 5. Up to now, an electrical heater 14 was always described as device for heating the fresh fuel gas. Alternatively or additionally to this electrical heater 14, other heat sources can also be used for heating the fresh fuel gas flow, especially in the region 7.2 of the integrated component part 7. In the fuel cell system 1, which is especially used for providing drive energy in a transport means motor vehicle are present different components that generate a high waste heat and have to be cooled. These could especially be component parts of power electronics or electromotive drive units, for example, for supplying components or the traction drive of the transport means equipped with the fuel cell system 1.

As illustrated in an exemplary manner in the depiction according to FIG. 4, a cooling heat exchanger 32 can be arranged in the region of those components to be cooled, in the region of power electronics 33 for an electrical drive motor 34. This cooling heat exchanger now takes on the function to correspondingly preheat the fuel gas from the pressure tank 5, which flows up the region of the cooling heat exchanger 32 via the valve device 6. Thereby, at least a part of the waste heat generated by the power electronics 33 is discharged from the region of this power electronics, so that a cooling of the power electronics 33 can be completely omitted, or that a low cooling performance is needed for cooling the power electronics 33. The heat exchanger 32 can designed so that corresponding channels are introduced into a housing of the power electronics 33, through which a fuel gas flows. This construction can now be designed as integrated into the integrated component unit 7 or mounted thereto. The heating of the fresh supplied fuel gas via the heat exchanger 32 can thereby be used instead of the previously described electrical heater 14 in all embodiments shown up to now. Additionally, the electrical heater 14 can possibly also still be present.

FIG. 5 illustrates a construction, which alternatively to this shows the cooling heat exchanger 32 directly in the region of the electrical machine 34, so that the fresh gas flow is heated directly by the electrical machine 34. The electrical machine 34 shall hereby be the electrical machine of an electrical drive for the transport means. A comparable use would however also be feasible with other electrical machines, for example the electrical machine of an air conveyor device for the cathode chamber 4 of the fuel cell 2, the electrical machine for the recirculation device 13 or the like. Alternatively or additionally to the direct integration of the cooling heat exchanger 32 in the region of the heat-conducting component, it would of course also be feasible to construct an additional cooling circuit, where a suitable medium flows through the cooling heat exchanger 32 on the one hand and a region of the integrated component unit 7, in which the fresh hydrogen flows, on the other hand. The heat input could then take place via the cooling medium of arbitrary component parts producing a waste heat in the region of the integrated component unit 7.

Otherwise, the stated embodiments for the electrical heater 14 are also valid for this type of heat input.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1-17. (canceled)

18. An apparatus for supplying a fuel cell in a fuel cell system with fuel gas, comprising:
a mixing region, where unused fuel gas mixes with fresh fuel gas;
a water precipitator;
a device for at least indirect heating of supplied fresh fuel gas; and
a receptor for a sensor for sensing state variables or chemical magnitudes of the fuel gas flowing to the anode,
wherein the mixing region, water precipitator, device and receptor are combined in an integrated component part.

19. The apparatus according to claim 18, wherein the apparatus is arranged in such a manner that cooling water of the fuel cell system passes through the integrated component part.

20. The apparatus according to claim 18, wherein the device for the at least indirect heating of the supplied fresh fuel gas is an electrical heater.

21. The apparatus according to claim 20, wherein the electrical heater is a central electrical heating element, which is connected to regions of the integrated component part to be heated via regions of heat-conducting material.

22. The apparatus according to claim 18, wherein the device for the at least indirect heating of the supplied fresh fuel gas is a cooling heat exchanger for at least one heat-generating component, wherein the fresh fuel gas at least partially cools the heat-generating component.

23. The apparatus according to claim 22, wherein the cooling heat exchanger comprises channels that pass the fuel gas, the channels are arranged in a region of the heat-generating component.

24. The apparatus according to claim 22, wherein a heat-generating component is integrated in the integrated component part.

25. The apparatus according to claim 22, wherein a heat-generating component is mounted to the integrated component part.

26. The apparatus according to claim 18, wherein at least one valve device for discharging water from the water precipitator is integrated in the integrated component part.

27. The apparatus according to claim 18, wherein a water trap is integrated in the integrated component part.

28. The apparatus according to claim 27, wherein the water trap is integrated in a flow direction of the fuel behind the mixing region.

29. The apparatus according to claim 18, wherein a recirculation conveyor unit is mounted to the integrated component part, the recirculation conveyer unit arranged to conduct unused fuel back from a region behind an anode of the fuel cell to a region in front of the anode.

30. The apparatus according to claim 18, wherein a recirculation conveyor device is at least partially integrated in the integrated component part, the recirculation conveyer unit arranged to conduct unused fuel back from a region behind an anode of the fuel cell to a region in front of the anode.

31. The apparatus according to claim 18, wherein electrical or electronic component units are mounted to the integrated component part.

32. The apparatus according to claim 18, wherein the integrated component part is a self-supporting unit.

33. The apparatus according to claim 18, wherein the integrated component part is an end plate of the fuel cell.

34. An apparatus for supplying a fuel cell in a fuel cell system with fuel gas, comprising:
a mixing region, where unused fuel gas mixes with fresh fuel gas;
a water precipitator;
a device for at least indirect heating of supplied fresh fuel gas; and
a receptor for a sensor for sensing state variables or chemical magnitudes of the fuel gas flowing to the anode,
wherein the mixing region, water precipitator, device and receptor are combined in an integrated component part, and wherein the apparatus is a component of the fuel cell system in a farm vehicle that operates without rails.
